(19) United States
(12) Patent Application Publication
(10) Pub. No.: US 2008/0299891 A1
(43) Pub. Date: Dec. 4, 2008

(54) Exhaust system with installation panel

(75) Inventor: Chaohua Deng, Zhongshan (CN)

Correspondence Address: YH CHAN, 42 PIN OAKS DRIVE, PHOENIXVILLE, PA, 19460, US

(73) Assignee: HANWAY Technology Co., Ltd.

(21) Appl. No.: 11/806,517

(22) Filed: May 31, 2007

(51) Int. Cl. F24F 7/06; F21V 33/00

(52) U.S. Cl. 454/354; 362/96

(57) ABSTRACT

A ventilating exhaust fan including a housing unit, a motor module, a panel module, and an exhaust assembly is provided. The exhaust assembly fixed on a side surface of the housing unit is improved by replacing single piece stopping flake with two-piece stopping flakes in order to reduce air flow friction, thereby overcoming the shortcoming of existing technique of stopping flake which, relying on gravity for reposition, gives rise to larger air flow friction. Furthermore, the noise of the existing pipeline exhaust fan is also reduced by adopting the methods of injection molding of motor module with volute as one entity, and by adhering to volute bottom sponge layer, which in turn is adhered to the base plate of exhaust fan housing.

### FIELD OF INVENTION

The present invention relates to a ventilating exhaust fan and, in particular, a pipeline exhaust fan with replaceable panel.

### BACKGROUND OF THE INVENTION

At the present, the traditional ceiling pipeline exhaust fan in the market consists primarily of panel, housing, motor, fan wheel and other accessories, wherein the panel is usually fixed with V hanger inside housing with very shallow snap-on groove; such being the case, in the process of installing the hanger, one must attach panel to the end face of housing as close as possible, but since operator cannot see the position of the snap-on groove, it is very difficult to get to snap-on groove with precision; moreover, it is very likely that the hanger falls through motor module trough which is fixed on the side wall of housing, thereby making it hard for the panel to install to its precise position. Further, the above installation method is mostly suitable only for light panels made of plastic or other light materials, and would be inapplicable to such panels as made of glass or ceramic materials; then one would have to use bolt to fasten panel and housing, hence much of the inconvenience to install and replace such panels.

### SUMMARY

The invented model aims to resolve aforementioned technical problems by overcoming technical shortcomings described above and offering instead exhaust system with installation panel.

The invented model of pipeline exhaust fan offers a technical solution by means of exhaust system with installation panel, which includes exhaust fan housing with an open frame on one side, motor module located within housing, panel module located on the end face of housing door, and motor module connecting with external power source through socket connectors. The model has the following characteristics: said panel module connects with housing and motor module through flexible connection fitting and thereby forms an integral entity.

The said panel module includes strut member, panel garnish member, and panel main body, whereas said strut member and exhaust fan housing are connected through fixture, and panel garnish member so connects with panel main body as to form one body; specifically, flexible connection fitting comprises the connection member that is attached to panel garnish member and can be moved horizontally to a settled position as to fix on strut member. On strut member are a number of keyholes which, commeasurable with connection member, are composed of slots and round apertures so connected as to share identical direction; located upon connection member's axis is the shoulder, which, being compatible with keyhole, is to go through keyhole's round aperture in order to lock into keyhole's slot. Upon the other end of connection member is the screw thread which serves to so connect panel garnish member with panel main body as to form an integral entity; upon connection member, location step is created between screw thread part and shoulder, whose distance to be between location step and shoulder ought to be equal to or slightly larger than the thickness at the edge of keyhole on panel strut member, whereas location step's radial size should be bigger than the diameter of keyhole's round aperture.

Or, said flexible connection fitting is fixed upon the bottom of panel module as garter spring whose two jaws extend outward in an arc shape; upon motor module's end face is the mounting base with two symmetrically placed long grooves, whereas garter spring's two jaws are to snap into two corresponding long grooves. Mounting base is placed on the volute of motor module to form one entity, whereas said long grooves, being perpendicular to the end face of volute, are so installed as to have the top parts above or higher than the end face of housing.

Base upon above feature, the present invention also offers improvement of existing pipeline exhaust fan on the reduction of noise by adopting the methods of injection molding of motor module with volute as one entity, and by adhering to volute bottom sponge layer, which in turn is adhered to the base plate of exhaust fan housing.

Moreover, in order to aid convenient replacement and repair of capacitor, the structure of motor module is improved to the effect that cover plate is fixed on volute while motor is fixed on cover plate, and that capacitor is located in capacitance box which has been molded as one entity with volute, and that the connecting wires of motor and capacitor are so connected as to lead to external power source through male and female socket connectors.

The proposed invention improves on the structure of exhaust assembly by replacing single piece stopping flake with two-piece stopping flakes in order to reduce air flow friction, thereby overcoming the shortcoming of existing technique of stopping flake which, relying on gravity for reposition, gives rise to larger air flow friction.

Thanks to the adoption of above techniques, the proposed model has the following good effects:

1. Panel module adopts flexible connection fitting adaptive to all kinds of materials, thereby facilitating easy installment and repair work on panel module.

2. Volute adheres to the bottom of housing, between which sponge layer is inserted as buffer to reduce noise of exhaust fan in operation.

3. Capacitor is placed in capacitance box on the volute, forming an integral entity with motor module, thereby making it easier for replacement and repair work.

4. Two pieces of stopping flakes, using springs for repositioning, are placed at the exit of exhaust assembly, thereby reducing friction of air passage.

### BRIEF DESCRIPTION OF THE DRAWINGS

The followings are the drawings and preferred embodiments to further illustrate the present invention:

FIG. 1 is an axonometric drawing of preferred embodiment 1 of the present invention of pipeline exhaust fan;

FIG. 2 is a three-dimensional drawing of the installed reflective cover, lamp socket and strip lamp in FIG. 1;

FIG. 3 is a three-dimensional drawing of the lamp cap and swivel gantry in FIG. 2;

FIG. 4 is a three-dimensional drawing of the reflective cover in FIG. 2;

FIG. 5 is a three-dimensional drawing of the panel module in FIG. 1;

FIG. 6 is a three-dimensional drawing of the connection member in FIG. 5;

FIG. 7 is a three-dimensional drawing of the panel strut member in FIG. 5;

FIG. 8 is a three-dimensional drawing of the connection member as installed along with panel garnish member and panel main body in FIG. 5;

FIG. 9 is a three-dimensional drawing of the exhaust assembly in FIG. 1;

FIG. 10 is a three-dimensional drawing of the stopping flake in FIG. 1;

FIG. 11 is a three-dimensional drawing of the installed exhaust assembly and stopping flake;

FIG. 12 is an axonometric drawing of the second practical preferred embodiment of the present invention of pipeline exhaust fan (this drawing does not show motor module (C) and exhaust assembly parts);

FIG. 13 is a three dimensional drawing of the garter spring in FIG. 12; and

FIG. 14 is a three dimensional drawing of the volute in FIG. 12.

### DETAILED DESCRIPTION OF THE INVENTION

### Preferred Embodiment 1

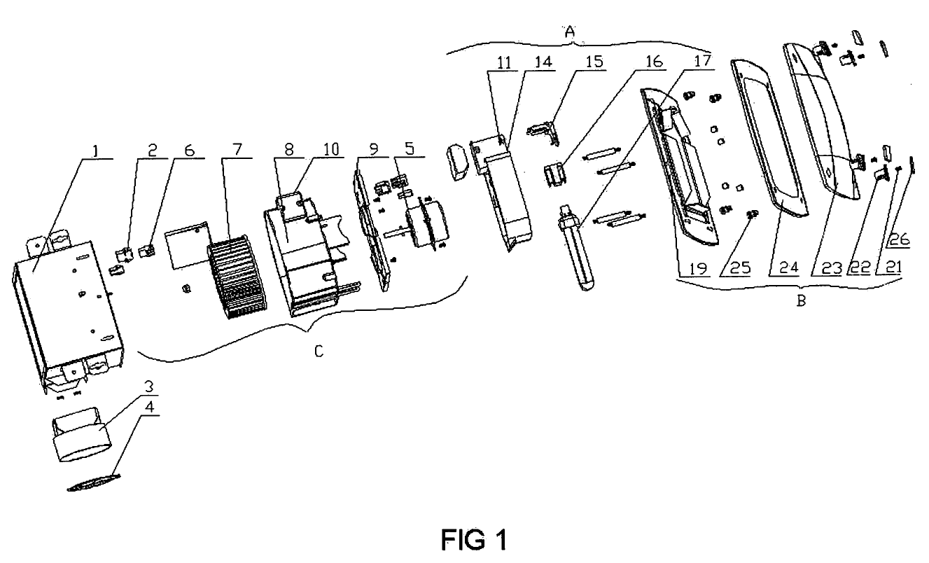

As shown in FIG. 1, the implemented pipeline exhaust fan includes housing 1 and the four following main parts placed on housing 1: panel module B placed on the end face of housing 1, motor module C placed in housing 1, light source module A placed between panel module B and motor module C, and exhaust assembly connected with vent-pipe and placed on outer side of housing 1.

As shown in FIG. 1 and FIGS. 5 through 8, this example indicates that panel module B of the exhaust fan consists of panel strut member 19, panel garnish member 24, panel main body 23, four panel connection members 25, bolt 21, bush 22 and garnish cover 26. Both panel garnish member 24 and panel strut member 19 are of hollow structure with frames. Panel strut member 19 uses bolts and nuts to connect with both housing 1 and motor module C to form one entity. Panel strut member 19 has four corners where keyholes 191 are made with slots and round apertures and aligned in identical direction. Connection member 25 is of cylinder shape, one end of which contains internal thread 252, wherein bolt 21 is to go through bush 22 to connect with internal thread 252, thereby consolidating panel garnish member 24 and panel main body 23 into one entity as shown in FIG. 8. In this setting the design of bush 22 is primarily to offset the limitation in processing art on panel main body 23 using glass and ceramic materials, as it is difficult to drill holes in glassware with high precision; therefore one may opt to use plastic materials to make bush 22 to be capped by garnish cover 26.

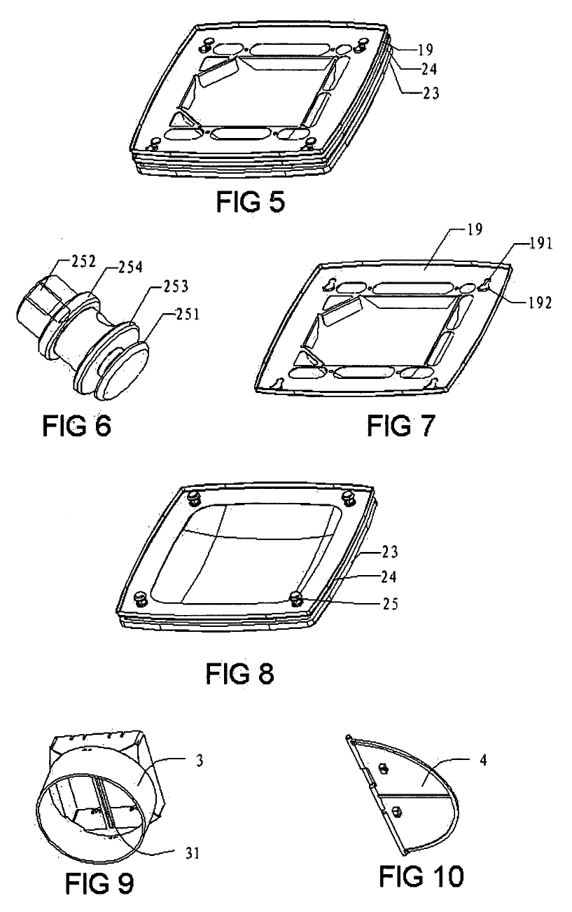

As shown in FIG. 6, on the other axial end of connection member 25 is located shoulder 251, to be commeasurable with keyholes: on the same axis whereupon shoulder 251 is, location steps 253 and 254 reside between shoulder 251 and screw thread 252; the distance between location step 253 and shoulder 251 is equal to or slightly larger than thickness of panel strut member 19 near keyhole 191, whereas the radial size of location step 253 is bigger than the diameter of the round aperture of keyhole 191. Location step 254 functions primarily to define the axial position of connection member 25 on panel garnish member 24. In installation one should insert connection member's 25 shoulder 251 through the round aperture of keyhole 191, and then move horizontally along slot to snap connection member 25 at keyhole 191 slot. This structural design is especially adaptive to such panel main body as made of glass or ceramics, because the greater weight of the latter would rule out the kind of snap device as used by panel main body 23 made of plastic materials to achieve quick and easy positioning. Therefore, by adopting above connection method, it is much easier and faster to attach such panel main body as made of glass or ceramics to housing 1 so as to form one entity. Moreover, on the back of panel strut member 19 near keyhole's 191 round aperture, there is a check block 192 with the same arc as round aperture, whose main function is to ensure that, as he moves panel main body 23 horizontally until shoulder 251 touches check block 192, the operator may pull off panel main body 23 along the axial line of round aperture without having to align precisely to the center of round aperture. Meanwhile, location steps 253 and 254 of connection member 25 would always provide certain space between panel main body 23, panel garnish member 24 and panel strut member 19, thereby enabling strip lamp 17 to dissipate heat; moreover, since location step 253 has an axial size greater than that of round aperture, its installation may have some ornamental effect by being able to cover keyhole 191.

As shown in FIG. 1, motor module C comprises primarily of volute 8, vane wheel 7, cover plate 9 and motor 5. Motor 5 and cover plate 9 are fixed together, whereupon vane wheel 7 is fixed to motor shaft, whereas cover plate 9 and volute 8 are fixed together; capacitor is fixed in capacitance box 10 which is molded together with volute 8 as one entity; both L line and ground line of motor 5 connect to male socket connector 6 jacket, thereby making motor module C an independent entity capable of connecting to external power source through male socket connector 6 and female socket connector 2. If capacitor needs repair or replacement, one can take out motor module C as an independent entity from housing 1. Also, sponge layer is adhered to the bottom of volute 8 (the drawing does not show this), which will then adhere to the bottom of housing 1 wherein volute 8 is installed, thereby reducing vibration and noise of exhaust fan in operation.

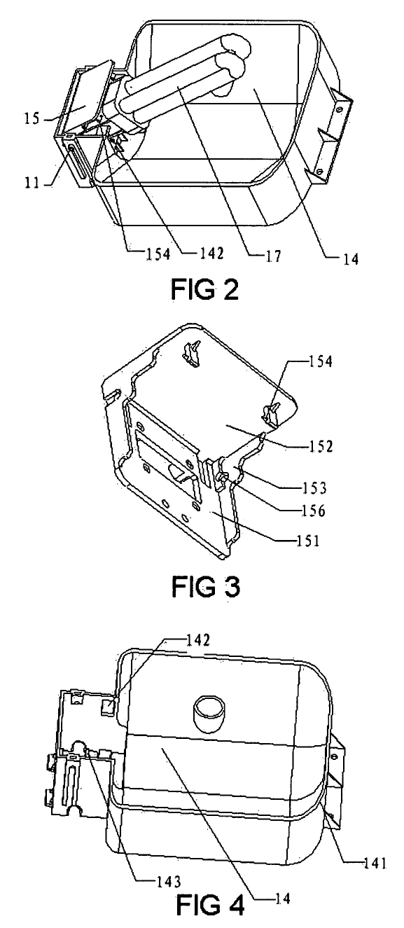

As shown in FIGS. 1 through 4, this example of present invention indicates that light source module A includes lamp socket 16, lamp cap swivel gantry 15 and reflective cover 14 for connecting energy-saving lamp 17 which is to snap into lamp socket 16. Lamp cap swivel gantry 15 is composed of mounting plate 151 and safely apron 152 placed upon mounting plate 151 to form L shape, whereupon joint plate 153 is located on both sides of lamp cap swivel gantry 15 so that reflective cover 14 should clip onto clip-on connecting aperture 156. Lamp socket 16 is bolt-fixed onto mounting plate 151 of lamp cap swivel gantry 15, whereas lamp cap swivel gantry 15 and reflective cover 14 clip onto each other through connecting shaft 11 of clip-on connecting aperture 156. Since reflective cover 14 is equipped with check block 143 at the bottom, lamp socket 16 can only turn in certain angles. Since lamp cap swivel gantry 15 adopts clip-on structure with free swivel, hook 154 is placed on inner side of safety apron 152 of lamp cap swivel gantry 15 along with a corresponding snap 142 positioned on reflective cover 154, thereby ensuring that, after energy-saving lamp 17 is installed, the strip lamp would lock into U-shape groove of reflective cover. To change energy-saving lamp 17, one may cause hook 154 to detach from snap 142, thereby enabling energy-saving lamp 17 and lamp socket 16 to turn together with lamp cap swivel gantry 15 to such angle so that one can conveniently take out strip lamp without bumping into a sealing plate 141 on the end face of the reflective cover 14 nor risking broken strip lamp that may harm the operator. Moreover, by turning strip lamp 17 to a point, the operator may be given needed space between strip lamp 17 and reflective cover 14 so as to reach into reflective cover 14 to take on and off strip lamp by hand-grasping it.

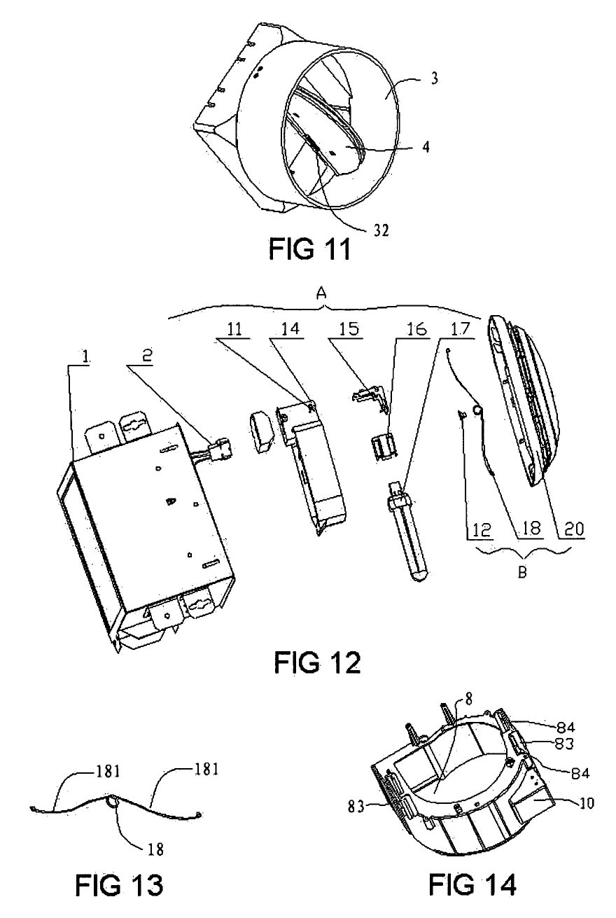

As shown in FIGS. 8 through 11, the present example indicates that exhaust assembly consists of exhaust assembly 3, two pieces of stopping flake 4, axis of rotation 31 and one or two pieces of torsion spring 32. Exhaust assembly 3 is, on one end, bolt-fixed to the side of housing 1 while it is, on the other end, connected with vent-pipe. The two pieces of half-circled stopping flake 4 and torsion spring 32 are installed on connecting shaft 31, whose two ends are, in turn, fixed onto the two pieces of stopping flake respectively. During the operation of exhaust fan, air flow will so overcome the elasticity of torsion spring 32 as to push open stopping flake 4 to go out through vent-pipe, but once exhaust fan stops working, the two pieces of stopping flake 4 will return to their original position by torsion spring 32 to close the exit door of exhaust assembly 3. Because of the lower elasticity of torsion spring, the friction against air flow is minimal.

To install exhaust fan, one should first install exhaust assembly onto housing 1 which is fixed on a wood piece, and then he should fix motor module C and panel strut member 19 onto housing 1; next one should install light source module A on cover plate 9 of motor module C; and lastly he should install panel module B by connecting connection member 25 with panel strut member 19 inside keyhole 191.

### Preferred Embodiment 2

Preferred Embodiment 2 differs from Example 1 in flexible connection fitting of panel module B. Example 1 can apply to panels made of both light and heavier materials such as ceramics and glass, whereas Example 2 employs flexible connection fitting which applies primarily to panels made of light materials such as plastics. As shown in FIGS. 12 through 14, Example 2 indicates that panel module B includes panel 20 composed of panel frame and transparent plate, spring suppress piece 12, garter spring 18 and set screw. Garter spring 18 has two jaws 181 spreading outward in arc, whereas spring suppress piece 12 has one end exerted into round aperture of garter spring 18 to be fixed onto panel frame of panel 20 by set screw.

Upon volute 8 of motor module where lies garter spring 18, there is a mounting base 83 with two long grooves 84 that are symmetrically placed and perpendicular to the end face of volute 8; the installation of volute 8 should ensure the top of long groove 84 to be higher than the opening end face of housing 1 whereas the two jaws 181 of garter spring 18 lock into long grooves 84. Since installed garter spring 18 ensures long groove 84 to be higher than the end face of housing 1, the operator may, while installing panel 20, see the position of long groove 84 to align it with much easy; moreover, since the two jaws 181 of garter spring 18 bend with an arc, once garter spring 18 lock into long groove 84, panel 19 would automatically usher into its designated and installed position.

What we claim is:

1. An exhaust system with installation panel comprises:
an exhaust fan housing open on one side;
a motor module mounted within the housing;
a panel module mounted as an end face on the opening side of the housing; and
an integral entity formed by the panel module and the motor module by means of a flexible connection fitting.

2. The exhaust system as claimed in claim 1, wherein the flexible connecting fitting further comprises a plurality of connection members mounted on a panel garnish member as well as on a strut member after horizontally moving to a designated position.

3. The exhaust system as claimed in claim 1 further comprises an exhaust assembly fixed on a side surface of the housing; two stopping flakes provided at the exhaust assembly located in the center of the rotation axis; a torsion spring provided surrounding the rotation axis, two ends of the torsion spring are fixed onto the two stopping flakes.

4. The exhaust system as claimed in claim 3, wherein the panel module further comprises:
a strut member;
a panel garnish member; and
a panel main body; the strut member is fixed onto the exhaust fan housing while the panel garnish member and the panel main body are connected together.

5. The exhaust system as claimed in claim 4 further comprises:
a conveniently replaceable light source;
a plurality of keyholes corresponding to a plurality of connection members mounted on the strut member; and
a plurality of slots and round apertures, which are aligned and connected with one another, the shoulder of the axial of the plurality of connection members corresponds with the keyholes allowing the shoulder to partly go into the round aperture of the keyhole and to snap into and stayed at the slot of the keyhole.

6. The exhaust system as claimed in claim 5 further comprises:
a screw thread member at one end of the connection member that connects the panel garnish member and panel main body to form an integrative part;
a location step is mounted between the screw thread member and the shoulder; the distance between the location step and the shoulder is equal to or slightly larger than the thickness of the panel strut member in the area around keyhole, while radial size of the location step is larger than the diameter of the keyhole round aperture.

7. The exhaust system as claimed in claim 6, wherein the rotation axis goes through the center of the exhaust assembly; and the stopping flakes are of half circle in shape.

8. The exhaust system as claimed in claim 1 further comprises an exhaust assembly fixed on the side surface of the housing; two stopping flakes provided at the exhaust assembly located in the center of the rotation axis; a torsion spring provided surrounding the rotation axis, two ends of the torsion spring are fixed onto the two stopping flakes.

9. The exhaust system as claimed in claim 8, wherein the flexible connection fitting further comprises:
a garter spring fixed on the bottom of the panel module, two jaws of the garter spring are of arc curvature extending outward;
a mounting base of the motor module provided at the end face where two long grooves are symmetrically placed; the two jaws of the garter spring are to be snapped into the two long grooves respectively.

10. The exhaust system as claimed in claim 9, wherein the mounting base is placed on the volute of the motor module and is integrated with the volute into one form; the long groove on the mounting base is perpendicular to the end face of the volute; after the volute is installed, the tip of the long groove of the mounting base is higher than the opening end face of the housing.

11. The exhaust system as claimed in claim 10, wherein the bottom of the volute of the motor module is adhered with a sponge layer, the sponge layer is attached to the base plate of the exhaust fan housing.

12. The exhaust system as claimed in claim 11 further comprises a cover plate fixedly connected to the volute, and the motor of the motor module is fixed on top of the cover plate; a capacitor is installed inside a capacitance box integrally formed by the volute, connecting wires out of the motor and the capacitor are connected and further connecting to the external power source through a male socket connector and a female socket connector.

13. The exhaust system as claimed in claim 12 further comprises an exhaust assembly fixed on the side surface of the housing; two stopping flakes provided at the exhaust assembly located in the center of the rotation axis; a torsion spring provided surrounding the rotation axis, two ends of the torsion spring are fixed onto the two stopping flakes.

14. The exhaust system as claimed in claim 13, wherein the rotation axis goes through the center of the exhaust assembly; and the stopping flakes are of half circle in shape.

15. An exhaust system with installation panel comprises:
an exhaust fan housing unit with an open surface;
a motor module mounted inside the housing unit;
a panel module mounted as an end face on the opening surface of the housing unit including a strut member and a panel garnish member; and
a flexible connection fitting including a plurality of connection members mounted on the panel garnish member as well as on the strut member.

16. The exhaust system as claimed in claim 15 further comprises an exhaust assembly fixed on a side surface of the housing unit; two stopping flakes provided at the exhaust assembly located in the center of a rotation axis for reducing air flow friction; and a torsion spring provided surrounding the rotation axis, two ends of the torsion spring are fixed onto the two stopping flakes.
